(19) United States
(12) Patent Application Publication
(10) Pub. No.: US 2005/0264027 A1
(43) Pub. Date: Dec. 1, 2005

(54) Vehicle access door for third row seat

(76) Inventor: Travis R. Howard, Fairdale, KY (US)

Correspondence Address: David W. Carrithers;CARRITHERS LAW OFFICE, PLLC, One Paragon Centre, 6060 Dutchman 's Lane, Suite 140, Louisville, KY, 40205, US

(21) Appl. No.: 11/142,559

(22) Filed: Jun. 1, 2005

Related U.S. Application Data
(60) Provisional application No. 60/575,375, filed on Jun. 1, 2004.

(51) Int. Cl. B60J 5/04

(52) U.S. Cl. 296/146.1

(57) ABSTRACT

A third side door assembly for a vehicle comprising a side door including a lower curved portion to cooperatively engage a curved portion of the vehicle body positioned over a rear wheel well of the vehicle. The third side door includes a hinge means on a front or rear side edge of the door cooperatively engaging hinge means mounted on a corresponding side edge portion of the vehicle body latch means for releasably holding the door in a closed position and includes means for biasing the door into a selected open position. The third side door can operated by a sliding mechanism instead of the hinge. The slidable mechanism includes a longitudinally slidable door third side door for providing access to a third row seat including a lower curved portion to cooperatively engage a portion of the vehicle body positioned over a rear wheel well of the vehicle, a guide bar mounted on the door and extending along the length thereof, a guide head slidably engaging the guide bar for slidably supporting the door, a supporting arm means connecting the guide head and the door for cooperatively engaging the guide head, latch means for releasably holding the door in a closed position, and spring means for biasing the door into a selected open position or closed position.

This application claims priority from U.S. Provisional Application Ser. No. 60/575,375 filed on Jun. 1, 2004 which is hereby incorporated by reference.

### BACKGROUND

This version of the invention is concerned with the field of access doors for passenger vehicles. More specifically, this version of the invention is concerned with an access door for the third row of seats in a minivan.

### PRIOR ART

Over the recent past, minivans have become increasingly popular as the vehicle of choice for families and certain types of businesses. Originally, minivans were manufactured with two front seats (driver and passenger), a second row of seats (two bucket seats or bench seat) located behind the front seats, and an open space for hauling and storing various items, said space located behind the second row of seats. Access to the interior of minivans typically consisted of a front driver door, front passenger door, and one or two doors located behind the front passenger door for access to the second row of seats and rear storage space. These doors were hingedly attached along one side edge thereof to the body of the minivan so that they could pivot along one side edge thereof to an opened position to allow access to the second row of seats and then pivot to a closed position.

More recently, the door to allow access to the second row of seats incorporates various types of sliding apparatuses that are used to allow the door to slide open to either forward or rearward of its initial closed position. These apparatuses may use a track system upon which the door slide or retractable or non-retractable arms that attach the door to the body of the minivan and support the door as it slides to opened and closed positions. The use of sliding doors permits a much larger door opening for access to the second row of seats, thereby facilitating entry to and exit from the second row of seats and the interior of the minivan.

In addition, the seating capacity of minivans has been increased by the addition of a third row of seats located behind the existing second row of seats and anterior of the vehicle's rear hatch. The third row of seats increases the seating capacity of a typical minivan to up to eight passengers. However, a passenger can experience difficulty reaching and leaving the third row of seats as the passenger must use the access door for the second row of seats and squeeze past the second row of seats to reach the third row of seats. The space between the end of the second row of seats and adjacent portion of the body of the minivan or third row of seats is usually confined, requiring the passenger to bend over, turn sideways, or otherwise assume an unnatural position to reach the third row of seats from the access door for second row seats. This situation can become even more difficult if either the second of third rows of seats are fully or partially occupied. Additionally, access tot he third row of seats in this manner can become especially burdensome if the passenger is overweight, elderly, or otherwise suffers from a medical problem, all of which can restrict body flexibility and movement.

What is needed then to overcome the aforementioned disadvantages of limited access to minivans with third row seats is the provision of an access door for third row seats on minivans that have a third row of seats. The access door would be located on the exterior of the body of the minivan behind the access door for the second row of seats and permit direct access to the third row of seats through a door opening located on either or both ends of the third row of seats. The access door would be either hingedly attached at one side edge thereof to the body of the minivan to allow the door to be pivotally opened and closed or slidingly attached to the body of the minivan so that the access door can slide to an opened position either forward or rearward of its initial closed position.

### DISCUSSION OF THE PRIOR ART

Numerous designs for vehicle access doors have been provided in the prior art. Even though these designs may be suitable for the specific individual purposes to which they address, they would not be suitable for the purpose of the present version of the invention as such designs are generally intended to improve the security of a vehicle access door or augment the access to the interior of a vehicle by existing access doors. These designs are exemplified by the following patents all of which are incorporated by reference herein: U.S. Pat. No. 4,025,104, Sliding Door For Vehicles, Especially Automobiles, issued to Grossbach et al. On 24 May 1977; U.S. Pat. No. 5,244,247, Door Installation Arrangement For Vehicle, issued to Kuwabara on 14 Sep. 1993; U.S. Pat. No. 5,398,988, Vehicle Door Assembly, issued to DeRees et al. on 21 Mar. 1995; U.S. Pat. No. 6,447,054, Vehicle Access System, issue to Pietryga et al. on 10 Sep. 2002; and U.S. Pat. No. 6,666,499, Limousine Utility Vehicle, issued to Stewart et al. on 23 Dec. 2003.

As such, it may be appreciated that there is a continuing need for a new and improved minivan access door for third row of seats. The access door would be located on the exterior of the body of the minivan to permit direct access to the third row of seats through a door opening adjacent to one or both ends of the third row of seats. The access door would be hingedly attached at one side edge thereof to the body of the minivan so that the door can be pivotally opened and closed or slidingly attached to the body of the minivan to permit the access door to slide to an opened position from an initial closed position. In these respects, the present version of the invention substantially departs from the conventional concepts and designs of the prior art, and in so doing provides an apparatus that substantially fulfills this need. Additionally, the prior patents and commercial techniques do not suggest the present inventive combination of component elements arranged and configured as disclosed herein.

The present invention achieves its intended purposes, objects, and advantages through a new, useful and unobvious combination of method steps and component elements, with the use of a minimum number of functioning parts, at a reasonable cost to manufacture, and by employing only readily available materials.

### SUMMARY

The present version of the invention, which will be described in greater detail hereinafter, relates to the field of access doors for passenger vehicles. More specifically, this version of the invention os concerned with an access door for the third row of seats in a minivan. My version of the invention overcomes all of the shortcomings listed previously, in addition to novel aspects that will be described in detail hereinafter.

A third side door assembly for a vehicle comprising a side door including a lower curved portion to cooperatively engage a curved portion of the vehicle body positioned over a rear wheel well of the vehicle. The third side door includes a hinge means on a front or rear side edge of the door cooperatively engaging hinge means mounted on a corresponding side edge portion of the vehicle body latch means for releasably holding the door in a closed position and includes means for biasing the door into a selected open position. The third side door can operated by a sliding mechanism instead of the hinge. The slidable mechanism includes a longitudinally slidable door third side door for providing access to a third row seat including a lower curved portion to cooperatively engage a portion of the vehicle body positioned over a rear wheel well of the vehicle, a guide bar mounted on the door and extending along the length thereof, a guide head slidably engaging the guide bar for slidably supporting the door, a supporting arm means connecting the guide head and the door for cooperatively engaging the guide head, latch means for releasably holding the door in a closed position, and spring means for biasing the door into a selected open position or closed position.

Described briefly, according to a first embodiment, the invention presents a door for third row of seats in a minivan. The door allows direct access to the third row of seats at either one or both ends of the row of seats through a dedicated door opening. The third row access door is located behind the access door for the second row of seats, forward of the rear hatch of the minivan, or adjacent ti either end of the third row of seats. The access door is comprised in part of an exterior panel, interior panel, a window, and a door handle/latch that us used to open, close, lock, and unlock the access door. In a first embodiment of the invention, the access door is hingedly attached along a forward side edge therefor to a body post of the minivan directly behind an access door for the second row of seats. In this manner, the third row access door can pivot to opened and closed positions from the front side edge thereof. In a second embodiment of the invention, the access door is hingedly attached along a rear side edge thereof to a body post of the minivan behind the door opening that allows access to the third row of seats. In this manner, the third row access door can pivot to opened and closed positions from the rear side edge thereof. In third and fourth embodiments of the invention, the third row access door is attached to the body of the minivan by a sliding apparatus that incorporates a retractable or non-retractable arms. The sliding apparatus permits the third row access door to slide to an opened position either forward or rearward of its initial closed position, With the aforementioned means of attaching the third row access door to the body of the minivan, the door permits direct access to the third row seat of a minivan through a dedicated door opening.

It is an object of the present invention to provide a third side door assembly for a vehicle, comprising a longitudinally slidable door third side door for providing access to a third row seat including a lower curved portion to cooperatively engage a portion of the vehicle body positioned over a rear wheel well of the vehicle; a guide bar mounted on the door and extending along the length thereof; a guide head slidably engaging the guide bar for slidably supporting the door; a supporting arm means connecting the guide head and the door for cooperatively engaging the guide head; latch means for releasably holding the door in a closed position; spring means for biaising the door into a selected open position or closed position.

It is another object of the present inventio to provide a third side door assembly for a vehicle, comprising a door including a lower curved portion to cooperatively engage a lower curved portion of the vehicle body positioned over a rear wheel well of the vehicle; the door including hinge means on a rear side edge of the door cooperatively engaging hinge means mounted on a rear side edge portion of the vehicle body; latch means for releasably holding the door in a closed position; and a means for biasing the door into a selected open position.

It is another object of the present invention to provide a third side door assembly for a vehicle, comprising a door including a lower curved portion to cooperatively engage a lower curved portion of the vehicle body positioned over a rear wheel well of the vehicle; the door including hinge means on a front side edge of the door cooperatively engaging hinge means mounted on a front side edge portion of the vehicle body; latch means for releasably holding the door in a closed position; and means for biasing the door into a selected open position.

My invention, therefore, resides not in any one of these features per se, but rather in the particular combination of all of them herein disclosed. It is distinguished from the prior art in this particular combination of all of its structures for the functions specified.

In order that the detailed description of the invention may be better understood and that the present contribution to the art can be more fully appreciated, additional features of the invention will be described hereinafter. It should be appreciated by those skilled in the art that the conception and the disclosed specific methods and structures may be readily utilized as a basis for modifying or designing other structures for carrying out the same purposes of the present invention. It should be realized by those skilled in the art that such equivalent methods and structures do not depart from the spirit and scope of the invention.

In this respect, before explaining a first embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application nor is it intended to be limiting as to the scope of the invention in any way.

Accordingly, it is an object of my version of the invention to provide a low-cost, easy-to-manufacture, and easy-to-market minivan access door for third row seat.

A further object of my version of the invention is to provide an easy-to-use and versatile minivan access door for third row seat.

A significant object of the invention is to provide a minivan access door for third row seat that is comprised of opposed exterior and interior panels, window, door handle/latch, and means of attachment to the body of a minivan, said means of attachment comprised either of a hinge apparatus by which the access door for third row seat can be pivotally attached to the body of a minivan at either the front or rear side edge of said door, thus permitting the access door to open and close from either said front or rear side edge, or slidingly attached to the body of the minivan using an apparatus having a track system of retractable arms, which permit the access door to slide to an open position that is forward or rearward of the closed position of said door.

A final but very significant object of the invention is to provide a minivan access door for third row seat that permits direct, unobstructed access to the third row seat of a minivan.

For a better understanding of the invention, its operating advantages and the specific objects attained by its uses, reference should be made to the accompanying drawings and descriptive matter in which there are illustrated preferred embodiments of the invention. The foregoing has outlined some of the more pertinent objects of the invention. These objects should be construed to be merely illustrative of some of the more prominent features and applications of the present invention. Many other beneficial results can be attained by applying the disclosed invention in a different manner or by modifying the invention within the scope of the disclosure. Accordingly, other objects and a fuller understanding of the invention may be had by referring to the summary of the invention and the detailed description of the preferred embodiments in addition to the scope of the invention illustrated by the accompanying drawings.

### BRIEF DESCRIPTION OF THE DRAWINGS

The foregoing and other objects, features and advantages of the invention will become more fully understood from the following description of the preferred embodiments of the invention as illustrated in the accompanying drawings in which like reference characters refer to the same parts throughout different views. The drawings are not necessarily to scale, emphasis instead being placed upon illustrating the principles of the invention.

FIG. 1 is a side elevation view of a conventional minivan.

FIG. 2 is a top plan view of a conventional minivan illustrating first, second, and third seating rows located within the interior thereof.

FIG. 3 is a side elevation view of a minivan fitted with a first embodiment of an access door for third row seat in accordance with the present version of the invention.

FIG. 4 is a side elevation view of a minivan fitted with a first embodiment of an access door for third row seat, illustrating the access door for third row seat in an opened position.

FIG. 5 is a side elevation view of a minivan fitted with a second embodiment of an access door for third row seat in accordance with the present version of the invention.

FIG. 6 is a side elevation view of a minivan fitted with a second embodiment of an access door for third row seat, illustrating the access door for third row seat in an opened position.

FIG. 7 is a side elevation view of a minivan fitted with a third embodiment of an access door for third row seat in accordance with the present version of the invention.

FIG. 8 is a side elevation view of a minivan fitted with a third embodiment of an access door for third row seat, illustrating the access door for third row seat in an opened position.

FIG. 9 is a side elevation view of a minivan fitted with a fourth embodiment of an access door for third row seat in accordance with the present version of the invention.

FIG. 10 is a side elevation view of a minivan fitted with a fourth embodiment of an access door for third row seat, illustrating the access door for third row seat in an opened position.

### DRAWING REFERENCE NUMERALS

10 Minivan
12 Body
14 Front Wheel
16 Rear Wheel
18a Front Passenger Door
18b Driver Door
20 Door Handle/Latch
22a Rear Passenger Door
22b Rear Passenger Door
24 Door Handle/Latch
26 Rear Hatch Door
28 Dashboard
30 Driver Seat
32 Front Passenger Seat
34 Console
36 Second Row Rear Seat
38 Third Row Rear Seat
40 Minivan With Access Door For Third Row Seat
42 Body
44 Front Wheel
46 Rear Wheel
48 Front Door
50 Door Handle/Latch
52 Rear Passenger Door
54 Door Handle/Latch
56 Access Door For Third Row Seat, First Embodiment
58 Exterior Panel
60 Window
62 Door Handle/Latch
64 Interior Panel
66 Body Post
68 Door Opening
70 Access Door For Third Row Seat, Second Embodiment
72 Exterior Panel
74 Window
76 Door Handle/Latch
78 Interior Panel
80 Body Post
82 Access Door For Third Row Seat, Third Embodiment
84 Exterior Panel
86 Window
88 Door Handle/Latch
90 Retractable Arm
92 Retractable Arm
94 Wheel Well
96 Access Door For Third Row Seat, Fourth Embodiment
98 Exterior Panel
100 Window
102 Door Handle/Latch
104 Retractable Arm
106 Retractable Arm

### DESCRIPTION OF THE PREFERRED EMBODIMENTS

### Description

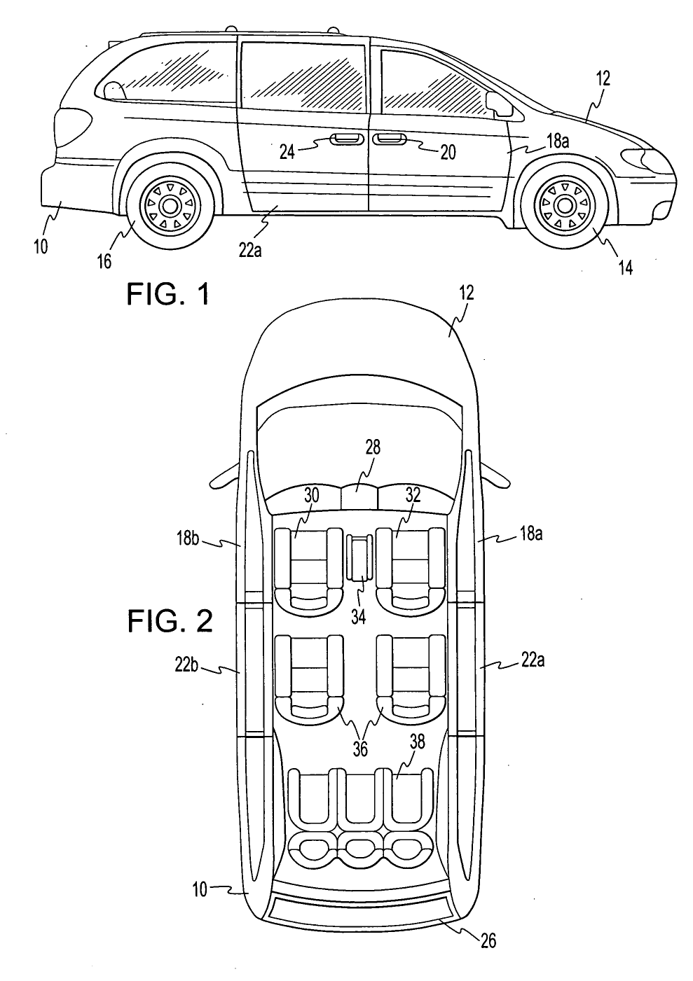

Referring now to the drawings and, in particular, to FIG. 1 wherein there is illustrated a conventional minivan 10 of the type currently being offered in the marketplace that has a front row of seats, second row of seats, and a third row of seats. The minivan 10 is comprised in part of a body 12, a front wheel 14, a rear wheel 16, front passenger door 18a with door handle latch 20, and a rear passenger door 22a, with door handle/latch 24. The rear passenger door 22a allows ingress and egress for passengers using the rear seats, typically the second and third rows of seats situated behind the front seats. The rear passenger door 22a can be attached to the body 12 of the minivan 10 either by a track system that allows the rear passenger door 22a to slide to an opened or closed position or by hinges so that said door 22a can pivot along one side thereof to opened and closed positions, as necessary.

In FIG. 2, the minivan 10 is illustrated in top plan view to reveal the interior layout thereof. A pivoting hatch door 26 is located at the rear end of the vehicle 10. Within the interior of the minivan 10, a dashboard 28 is located at the front thereof, and a driver seat 30 and front passenger seat 32 are situated behind the dashboard 28. A console 34 located between the front driver seat 30 and front passenger seat 32. A pair of seats 36 functioning as the second row of seats is located behind the front driver seat 30 and front passenger seat 32, and a third row of seats 38 is located behind the second row of seats 36.

The front passenger door 18a and front driver door 18b flank the front driver seat 30 and front passenger seat 32. The minivan may also be equipped with an optional second rear passenger door 22b, as illustrated, to provide more access to the second 36 and third 38 row of seats. In many cases, however, the minivan 10 is provided with only one rear passenger door 22a.

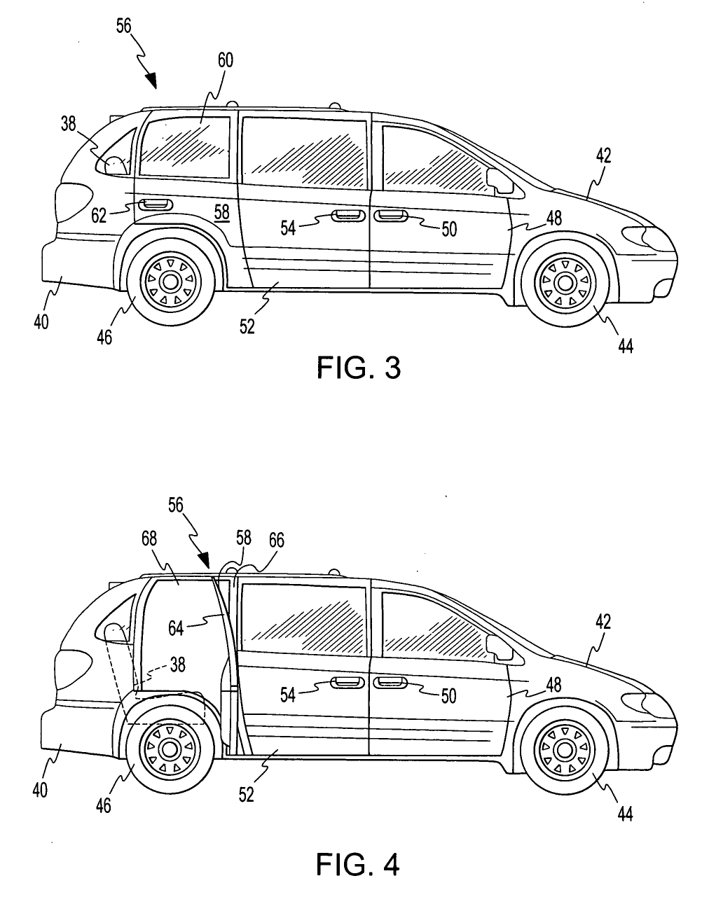

Referring to FIG. 3, therein illustrated is a minivan 40 outfitted with access door for third row seats 38. The minivan 40 is comprised in part of a body 42, a front wheel 44, a rear wheel 46, front passenger door 48 with door handle latch 50, and a rear passenger door 52 with door handle/latch 54. A first embodiment of access door for third row seat 56 is located on the body 42 of the minivan behind 40 the rear passenger door 52. The third row access door 56 consists in part of an exterior panel 58, window 60, and door handle/latch 62. The door handle/latch 62 is located proximate to the rear side edge of the third row access door 56. The door 56 is attached along a front side edge thereof to the body 42 of the minivan 40, thus allowing the door 56 to pivot open and close along said front side edge. As shown, in FIG. 4, the door 56 is pivoted open to reveal partially an interior panel 64 that faces the interior of the minivan 40 when the door 56 is in the closed position. The door 56 is attached along said front side edge by hinges or similar mechanisms to a body post 66 that is located behind the rear passenger door 52 and thus pivots to and from opened and closed positions from said point of attachment. In the opened position, as illustrated, access to the third row seat 38 is provided by door opening 68. The door 56 can be located on one or both sides of the body 42 of the minivan 40 behind one or both rear passenger doors 52, should the minivan 40 have one or two rear passenger doors 52. Alternately, the minivan 40 can have two third row access doors 56 in the position as described and illustrated even if the body 42 is equipped with only one rear passenger door 52.

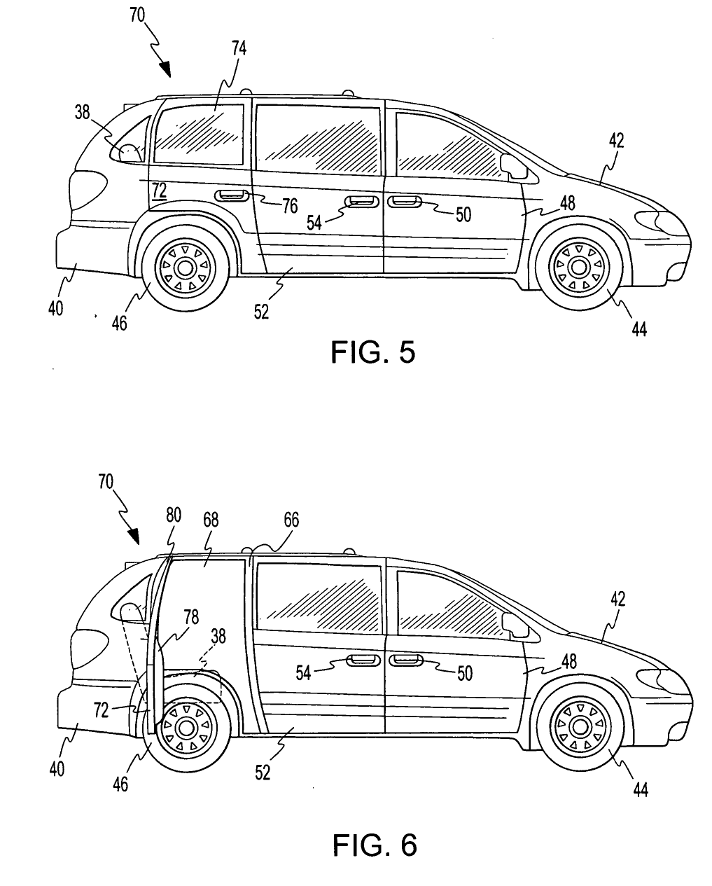

A second embodiment of access door for third row seat 70 is illustrated in FIG. 5. The door 70 is located on the body 42 of the minivan behind 40 the rear passenger door 52. The third row access door 70 consists in part of an exterior panel 72, window 74, and door handle/latch 76. The door handle/latch 76 is located proximate to the front side edge of the third row access door 70. The door 70 is attached along a rear side edge thereof to the body 42 of the minivan 40, thus allowing the door 56 to pivot open and close along said rear side edge. As shown, in FIG. 6, the door 70 is pivoted open to reveal partially an interior panel 78 that faces the interior of the minivan 40 when the door 70 is in the closed position. The door 70 is attached along said rear side edge by hinges or similar mechanisms to a body post 80 that is located behind the door 70 and thus pivots to and from opened and closed positions from said point of attachment. In the opened position, as illustrated, access to the third row seat 38 is provided by door opening 68. The door 70 can be located on one or both sides of the body 42 of the minivan 40 behind one or both rear passenger doors 52, should the minivan 40 have one or two rear passenger doors 52. Alternately, the minivan 40 can have two third row access doors 70 in the position as described and illustrated even if the body 42 is equipped with only one rear passenger door 52.

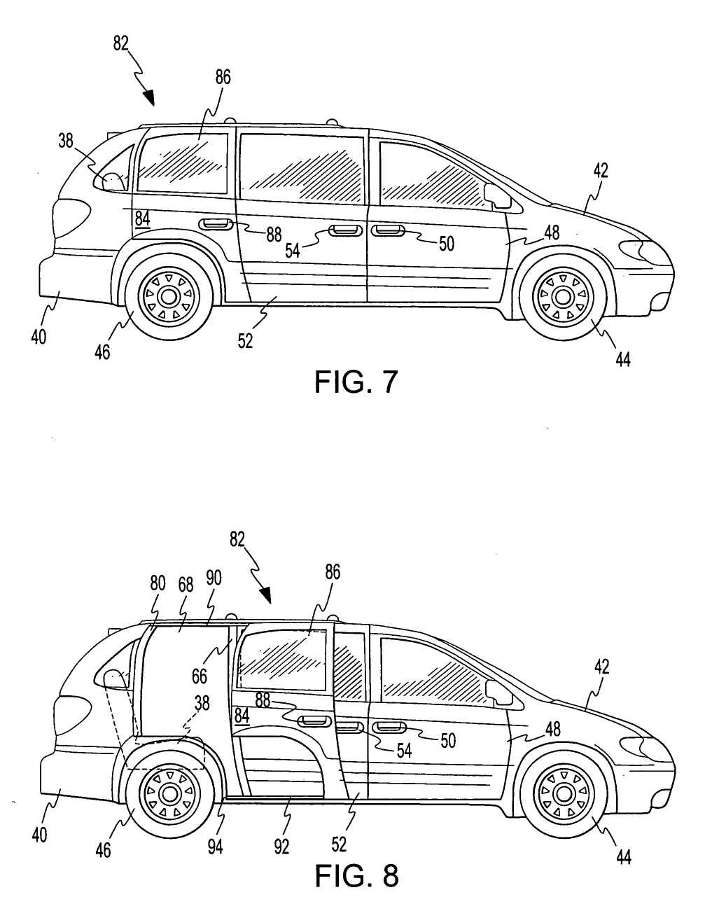

A third embodiment of access door for third row seat 82 is illustrated in FIG. 7. The door 82 is located on the body 42 of the minivan behind 40 the rear passenger door 52. The third row access door 82 consists in part of an exterior panel 84, window 86, and door handle/latch 88. The door 82 is attached to the body 42 of the minivan 40 using a sliding apparatus that permits the door 82 to slide to an opened position for access to the third row seat 38 and then slide to a closed position. In this embodiment, as shown, in FIG. 8, the door 82 slides to an opened position, which is forward of its initial closed position, as shown in FIG. 7. The door 82 is attached to the body by an upper retractable arm 90 and lower retractable arm 92. The upper retractable arm 90 at a first end thereof is attached to the door 82 and at a second opposed end attached to the rear body post 80. The lower retractable arm 92 at a first end thereof is attached to the door 82 and at a second opposed end attached to the body 42 at a rear wheel well 94. In the opened position, as illustrated, access to the third row seat 38 is provided by door opening 68. The door 82 can be located on one or both sides of the body 42 of the minivan 40 behind one or both rear passenger doors 52, should the minivan 40 have one or two rear passenger doors 52. Alternately, the minivan 40 can have two third row access doors 82 in the position as described and illustrated even if the body 42 is equipped with only one rear passenger door 52.

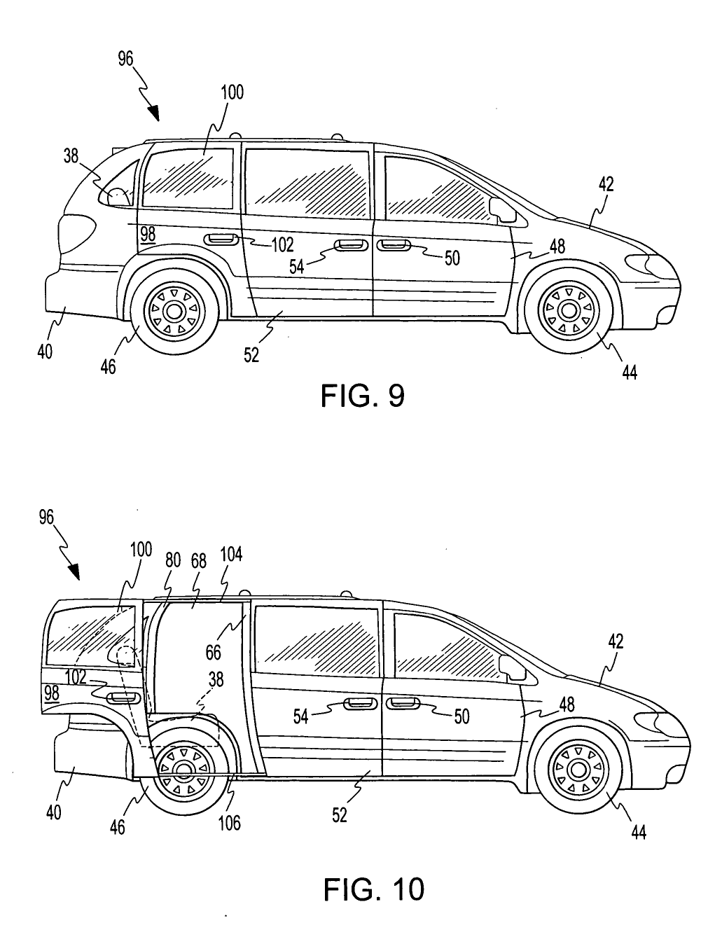

A fourth embodiment of access door for third row seat 96 is illustrated in FIG. 9. The door 96 is located on the body 42 of the minivan behind 40 the rear passenger door 52. The third row access door 96 consists in part of an exterior panel 98, window 100, and door handle/latch 102. The door 96 is attached to the body 42 of the minivan 40 using a sliding apparatus that permits the door 96 to slide to an opened position for access to the third row seat 38 and then slide to a closed position. In this embodiment, as shown, in FIG. 10, the door 96 slides to an opened position, which is rearward of its initial closed position, as shown in FIG. 9. The door 96 is attached to the body by an upper retractable arm 104 and lower retractable arm 106. The upper retractable arm 104 at a first end thereof is attached to the door 96 and at a second opposed end attached to the body post 66 located behind the rear passenger door 52. The lower retractable arm 106 at a first end thereof is attached to the door 96 and at a second opposed end attached to the body 42 at body post 66. In the opened position, as illustrated, access to the third row seat 38 is provided by door opening 68. The door 96 can be located on one or both sides of the body 42 of the minivan 40 behind one or both rear passenger doors 52, should the minivan 40 have one or two rear passenger doors 52. Alternately, the minivan 40 can have two third row access doors 96 in the position as described and illustrated even if the body 42 is equipped with only one rear passenger door 52.

While this version of the invention has been illustrated and described in detail in the drawings and foregoing description, the same is to be considered as illustrative and not restrictive in character, it being understood that only the preferred embodiments have been shown and described and that all changes and modifications that come within the spirit of the version of the invention are desired to be protected. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

### CONCLUSION AND SCOPE OF INVENTION

From the foregoing, it will be understood by persons skilled in the art that an improved minivan access door for third row seat has been provided. The invention is relatively simple and easy to manufacture, yet affords a variety of uses. While my description contains many specificities, these should not be construed as limitations on the scope of the version of the invention, but rather as an exemplification of the preferred embodiments thereof. The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be resorted to, falling within the scope of the invention. Although this invention has been described in its preferred form with a certain degree of particularity, it is understood that the present disclosure of the preferred form has been made only by way of example and numerous changes in the details of construction and combination and arrangement of parts may be resorted to without departing from the spirit and scope of the invention.

1. A third side door assembly for a vehicle, comprising:
a longitudinally slidable door third side door for providing access to a third row seat including a lower curved portion to cooperatively engage a portion of said vehicle body positioned over a rear wheel well of the vehicle;
a guide bar mounted on said door and extending along the length thereof;
a guide head slidably engaging said guide bar for slidably supporting said door;
a supporting arm means connecting said guide head and said door for cooperatively engaging said guide head;
latch means for releasably holding said door in a closed position;
spring means for biasing said door into a selected open position or closed position.

2. A third side door assembly for a vehicle, comprising:
a door including a lower curved portion to cooperatively engage a lower curved portion of the vehicle body positioned over a rear wheel well of the vehicle;
said door including hinge means on a rear side edge of said door cooperatively engaging hinge means mounted on a rear side edge portion of said vehicle body; and
latch means for releasably holding said door in a closed position;
means for biasing said door into a selected open position.

3. A third side door assembly for a vehicle, comprising:
a door including a lower curved portion to cooperatively engage a lower curved portion of the vehicle body positioned over a rear wheel well of the vehicle;
said door including hinge means on a front side edge of said door cooperatively engaging hinge means mounted on a front side edge portion of said vehicle body;
latch means for releasably holding said door in a closed position; and
means for biasing said door into a selected open position.
